(19) United States
(12) Patent Application Publication
(10) Pub. No.: US 2026/0243336 A1
(43) Pub. Date: Aug. 20, 2026

(54) DEVICE FOR CONTINUOUSLY VARIABLE TORQUE TRANSMISSION

(71) Applicants: VIKTOR ALEXANDROVICH KHONIN, LADUSHKIN (RU); YURIY VIKTOROVICH KHONIN, LADUSHKIN (RU)

(72) Inventors: VIKTOR ALEXANDROVICH KHONIN, LADUSHKIN (RU); YURIY VIKTOROVICH KHONIN, LADUSHKIN (RU)

(21) Appl. No.: 19/149,774

(22) PCT Filed: Nov. 9, 2023
(86) PCT No.: PCT/RU2023/000340

§ 371 Date: Jul. 21, 2025

(51) Int. Cl. F16H 37/08

(52) U.S. Cl. CPC F16H 37/084; F16H 37/0806

(57) ABSTRACT

A device for continuously variable torque transmission belongs to the field of mechanical engineering and can be used to continuously vary the speed of rotation of the shaft (Sh) and torque. The device for continuously variable torque transmission consists of a housing 1, drive 2, driven 3, an auxiliary 4 and the other 5 Sh, a gear 6 is rigidly fixed on the drive Sh 2, which is engaged with a cylindrical toothed wheel (CTW) 7, rigidly fixed on one auxiliary Sh 4 and with a CTW 8 rigidly fixed on another auxiliary Sh 5, the axes of the differential pinions 9 and 10 are rigidly fixed on the auxiliary Sh 4 and 5, perpendicular to them, at the ends of which two cone-shaped toothed wheels (CSTW) 11 and 12 are freely fixed, which are in contact with the CTW of differentials 13, 14 and 15, 16 freely fixed on auxiliary Sh 4 and 5, one CSTW of the differential 13 on one auxiliary Sh 4 is rigidly connected to a CTW 17, which is freely fixed on the same Sh 4 and is in contact with a CTW 18, rigidly fixed on a flanged bush (FB) 19, freely fixed on the drive Sh 2, another CSTW 14 of the same differential is rigidly connected to a CTW 20, which is also freely fixed on this Sh 4 and which is in contact with a CTW 21 rigidly fixed on the driven Sh 3, on the other auxiliary Sh 5, one CSTW of the differential 15 is rigidly connected to a CTW 22, which is freely fixed on the same Sh 5 and is engaged with a CTW 23 freely fixed on a FB 19, another CSTW 16 of the same differential is rigidly connected to a CTW 24, which is freely fixed on the same Sh 5 and which is in contact with a CTW 21 rigidly fixed on the driven Sh 3, on a FB 19 between a CTW 18 rigidly fixed on a FB 19, and the flange of the FB 19, there is a sliding bush with a disc 25, into which the fork lever 26 enters, mounted on an axis 27 in the housing 1, moreover, there is a support bearing 28 between the fork lever 26 and a disk of the bush with a disk 25, levers 30 are installed diametrically opposite on the axes 29 in the flange of the FB 19, which touch the disk of the bush with a disk 25 with one end, and enter the holes of the CTW 23 with the other end, which is freely fixed on the FB 19, at the same time, springs 31 are installed between the ends of the levers 30 touching the disk of the bush with a disk 25 and the flange of the FB 19.

### FIELD OF THE INVENTION

The proposed technical decision relates to the field of mechanical engineering and can be used to continuously vary the speed of shaft rotation and torque.

### BACKGROUND OF THE INVENTION

A technical decision is known, for example, a cone-shaped friction transmission with parallel axes, (see Machine Details by I.I. Markhel, Mashinostroenie publisher, 1977, chapter 2, page 35, FIG. 2.6), which consists of a drive shaft with a cone fixed on it, a driven shaft with a cone attached to it, which is parallel to the drive shaft, with a taper angle equal to the taper angle of the driving cone, in such a way that the vertices of the cones are directed in opposite directions and a friction roller fixed on its own axis parallel to the working surfaces of the cones, in the middle of them in the plane, passing through the axis of symmetry of the shafts.

The friction roller is in contact with the working surfaces of the cones and is positioned perpendicular to them. When the driving cone rotates due to the friction forces, there is a rotation of the roller between the working surface of the cone and the friction roller. The roller in contact with the surface of the driven cone, rotates it due to the friction forces between the roller and the surface of the driven cone. The friction roller can move on an axis along the surfaces of the cones, thereby changing the transmission ratios, which is achieved by the fact that the cone has different diameters in its different sections and when the roller is moved to different sections of the cones, the ratio between the diameters of the leading and driven cones at the point of contact with the friction roller changes.

The advantage of frictional engagement transmission is the ability to smoothly change transmission ratios.

Disadvantages of frictional engagement transmission are low transmitted power, low wear resistance.

The common features of the proposed decision and the analogue described above are the transmission of rotation from the drive shaft to the driven shaft with a continuously variable speed of rotation of the driven shaft.

The disadvantage of this transmission is the inability to transfer rotation between the drive and driven shafts by engagement due to normal forces.

The reason for the impossibility of obtaining a technical result is that this layout diagram is designed to work with the transmission of rotation between the drive and driven shafts using friction (friction method).

A mechanical engagement transmission with variable transmission ratios is known (see the description of the patent of the Russian Federation No. 2154759).

The transmission includes a rotation transmission unit, a drive and a driven cones. The rotation transmission unit contains a pinion of the drive cone, a central gear and a pinion of the driven cone. The rotation is transmitted using hemispherical projections on pinions and hemispherical recesses on cones. Hemispherical recesses and projections are located at equal distances from each other on the surface of the shape-generating figures.

The technical result is a smooth change in transmission ratios when transferring torque from one shaft to another by means of mechanical engagement.

The disadvantage of this transmission is that the insignificant transmitted power does not allow the transmission of torque using a toothed transmission.

A continuously variable transmission is also known (RU No. 2151935, dated Jun. 5, 1998). The transmission consists of a drive and a driven shaft, a cylinder which axis of rotation coincides with the axis of rotation of the drive shaft located inside the cylinder, U-shaped plates of equal length located in the radial grooves of the drive shaft with the possibility of reciprocating movement, which enter one another with their grooves, and contact the inner surface of the cylinder with their ends, rollers, which are provided with the protruding ends of the plates, and teeth pivotally connected to each other in an endless ribbon, sliding along the surface of the contour, which has a cross section similar to the inner section of the cylinder, with the outer teeth of the endless ribbon in contact with the rollers, its inner teeth-with the driven shaft.

The disadvantages of this transmission are that this design does not allow the transmission of torque using a toothed transmission;
insufficient load-carrying ability;
insufficient operational reliability;
low efficiency.

### SUMMARY OF THE INVENTION

The summary of the proposed technical decision is that the device for continuously variable torque transmission consists of a housing, drive, driven, an auxiliary and the other shafts, a gear is rigidly fixed on the drive shaft, which is engaged with a cylindrical toothed wheel, rigidly fixed on one auxiliary shaft and with a wheel rigidly fixed on another auxiliary shaft, the axes of the differential pinions are rigidly fixed on the auxiliary shafts, perpendicular to them, at the ends of which two cone-shaped toothed wheels are freely fixed, which are in contact with the cone-shaped toothed wheels of differentials freely fixed on auxiliary shafts, one cone-shaped toothed wheel of the differential on one auxiliary shaft is rigidly connected to a cylindrical toothed wheel, which is freely fixed on the same shaft and is in contact with a cylindrical toothed wheel, rigidly fixed on a flanged bush, freely fixed on the drive shaft, another cone-shaped toothed wheel of the same differential is rigidly connected to a cylindrical toothed wheel, which is also freely fixed on this shaft and which is in contact with a cylindrical toothed wheel rigidly fixed on the driven shaft, on the other auxiliary shaft, one cone-shaped toothed wheel of the differential is rigidly connected to a cylindrical toothed wheel, which is freely fixed on the same shaft and is engaged with a cylindrical toothed wheel freely fixed on a flanged bush, another cone-shaped toothed wheel of the same differential is rigidly connected to a cylindrical toothed wheel, which is freely fixed on the same shaft and which is in contact with a cylindrical toothed wheel rigidly fixed on the driven shaft, on a flanged bush between a cylindrical toothed wheel rigidly fixed on a flanged bush, and the flange of the flanged bush, there is a sliding bush with a disc, into which the fork lever enters, mounted on an axis in the housing, moreover, there is a support bearing between the fork lever and a disk of the bush with a disk, levers are installed diametrically opposite on the axes in the flange of the flanged bush, which touch the disk of the bush with a disk with one end, and enter the holes of the cylindrical toothed wheel with the other end, which is freely fixed on the flanged bush, at the same time, springs are installed between the ends of the levers touching the disk of the bush with a disk and the flange of the flanged bush.

During the embodiment of the invention, the following technical result is achieved
a continuously variable torque transmission in transmission ratios when transferring torque from one shaft to another by means of mechanical engagement.

A comparative analysis with analogues makes it possible to conclude that the claimed technical decision differs in the following: a gear is rigidly fixed on the drive shaft, which is engaged with a cylindrical toothed wheel, rigidly fixed on one auxiliary shaft and with a cylindrical toothed wheel rigidly fixed on another auxiliary shaft, the axes of the differential pinions are rigidly fixed on the auxiliary shafts, perpendicular to them, at the ends of which two cone-shaped toothed wheels are freely fixed, which are in contact with the cone-shaped toothed wheels of differentials freely fixed on auxiliary shafts, one cone-shaped toothed wheel of the differential on one auxiliary shaft is rigidly connected to a cylindrical toothed wheel, which is freely fixed on the same shaft and is in contact with a cylindrical toothed wheel, rigidly fixed on a flanged bush, freely fixed on the drive shaft, another cone-shaped toothed wheel of the same differential is rigidly connected to a cylindrical toothed wheel, which is also freely fixed on this shaft and which is in contact with a cylindrical toothed wheel rigidly fixed on the driven shaft, on the other auxiliary shaft, one cone-shaped toothed wheel of the differential is rigidly connected to a cylindrical toothed wheel, which is freely fixed on the same shaft and is engaged with a cylindrical toothed wheel freely fixed on a flanged bush, another cone-shaped toothed wheel of the same differential is rigidly connected to a cylindrical toothed wheel, which is freely fixed on the same shaft and which is in contact with a cylindrical toothed wheel rigidly fixed on the driven shaft, on a flanged bush between a cylindrical toothed wheel rigidly fixed on a flanged bush, and the flange of the flanged bush, there is a sliding bush with a disc, into which the fork lever enters, mounted on an axis in the housing, moreover, there is a support bearing between the fork lever and a disk of the bush with a disk, levers are installed diametrically opposite on the axes in the flange of the flanged bush, which touch the disk of the bush with a disk with one end, and enter the holes of the cylindrical toothed wheel with the other end, which is freely fixed on the flanged bush, at the same time, springs are installed between the ends of the levers touching the disk of the bush with a disk and the flange of the flanged bush.

Thus, the claimed technical decision meets the criteria of novelty.

### DESCRIPTION OF THE DRAWINGS

Summary of the invention is explained by the following description and drawings:

FIG. 1—Functional diagram of the device;

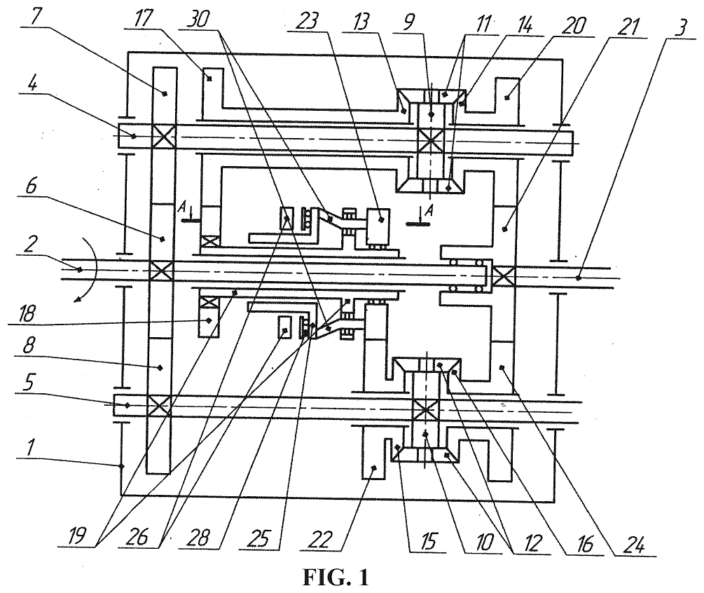

FIG. 2—section by A-A in FIG. 1.

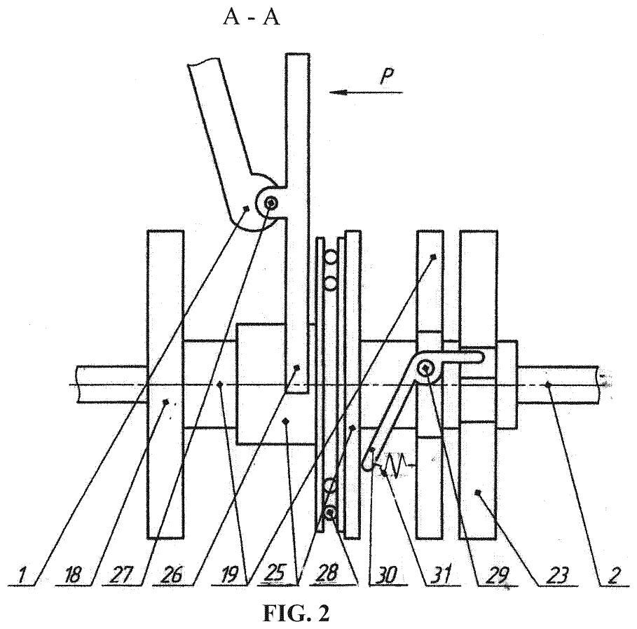

### DETAILED DESCRIPTION OF THE INVENTION

A device for continuously variable torque transmission consists of a housing 1, drive 2, driven 3, an auxiliary 4 and the other 5 shafts, a gear 6 is rigidly fixed on the drive shaft 2, which is engaged with a cylindrical toothed wheel 7, rigidly fixed on one auxiliary shaft 4 and with a cylindrical toothed wheel 8 rigidly fixed on another auxiliary shaft 5, the axes of the differential pinions 9 and 10 are rigidly fixed on the auxiliary shafts 4 and 5, perpendicular to them, at the ends of which two cone-shaped toothed wheels 11 and 12 are freely fixed, which are in contact with the cone-shaped toothed wheels of differentials 13, 14 and 15, 16 freely fixed on auxiliary shafts 4 and 5, one cone-shaped toothed wheel of the differential 13 on one auxiliary shaft 4 is rigidly connected to a cylindrical toothed wheel 17, which is freely fixed on the same shaft 4 and is in contact with a cylindrical toothed wheel 18, rigidly fixed on a flanged bush 19, freely fixed on the drive shaft 2, another cone-shaped toothed wheel 14 of the same differential is rigidly connected to a cylindrical toothed wheel 20, which is also freely fixed on this shaft 4 and which is in contact with a cylindrical toothed wheel 21 rigidly fixed on the driven shaft 3, on the other auxiliary shaft 5, one cone-shaped toothed wheel of the differential 15 is rigidly connected to a cylindrical toothed wheel 22, which is freely fixed on the same shaft 5 and is engaged with a cylindrical toothed wheel 23 freely fixed on a flanged bush 19, another cone-shaped toothed wheel 16 of the same differential is rigidly connected to a cylindrical toothed wheel 24, which is freely fixed on the same shaft 5 and which is in contact with a cylindrical toothed wheel 21 rigidly fixed on the driven shaft 3, on a flanged bush 19 between a cylindrical toothed wheel 18 rigidly fixed on a flanged bush 19, and the flange of the flanged bush 19, there is a sliding bush with a disc 25, into which the fork lever 26 enters, mounted on an axis 27 in the housing 1, moreover, there is a support bearing 28 between the fork lever 26 and a disk of the bush with a disk 25, levers 30 are installed diametrically opposite on the axes 29 in the flange of the flanged bush 19, which touch the disk of the bush with a disk 25 with one end, and enter the holes of the cylindrical toothed wheel 23 with the other end, which is freely fixed on the flanged bush 19, at the same time, springs 31 are installed between the ends of the levers 30 touching the disk of the bush with a disk 25 and the flange of the flanged bush 19, ensuring that the levers 30 are held in the starting position.

The device operates as follows. The torque from the power unit enters through the drive shaft 2 to the gear 6, which will begin to rotate the wheels 7 and 8, shafts 4 and 5, the axes of the differential pinions 9 and 10 in the opposite direction. At the beginning of the device's operation, when the external torque is maximum and the wheel 21 with the driven shaft 3 are at rest, the entire torque will rush into the device. The axis 9 of the differential pinions will begin to roll the pinions 11 along the wheel 14, increasing the rotation speed of the wheel 13 twice, which through the wheel 17 will transfer torque to the wheel 18 and the flanged bush 19, but in the opposite direction, i.e. along the rotation of the drive shaft 2. The other axis 10 of the differential pinions will roll the pinions 12 along the wheel 16, also doubling the rotation speed of the wheel 15, which will transfer torque through the wheel 22 to the wheel 23, also in the opposite direction, i.e. along the rotation of the drive shaft 2. Since all the cylindrical toothed wheels of the device are equal to each other, an internal closed force flow has been formed. In order to transfer torque to the wheel 21 and the driven shaft 3, it is necessary to slow down the wheels 17, 13 and 22, 15. For these purposes, a reactive torque mechanism of the device has been created, which consists of a wheel 18, a flanged bush 19, a sliding bush with a disc 25, a fork lever 26, a support bearing 28, levers 30, springs 31 and a wheel 23. In order for the reactive torque to begin to function as a brake on the wheels 17, 13 and 22, 15, it is necessary to drive the fork lever 26 towards the support bearing 28. The drive mechanism of the fork lever 26 can be: mechanical; hydraulic; pneumatic; electric and so on. As soon as the fork lever 26, through the support bearing 28 and the sliding bush with the disc 25, exerts pressure on one arm of the lever 30 through the axis 29 and the other arm of the lever 30 through the holes of the wheel 23 onto the wheel 23 towards the rotation of the wheels 22 and 15, and the axis 29, fixed in the flange of the flanged bush 19, through the wheel 18 will exert the same pressure towards the rotation of the wheels 17 and 13, the torque will receive resistance. If the value of reactive torque is sufficient to overcome the external torque, then part of the torque will rush towards the external torque through the wheels 14, 20 and 16, 24, spinning the wheel 21 and the driven shaft 3 with acceleration in the direction of the drive shaft 2. The acceleration of the rotation of the driven shaft 3 will occur until the reactive and external moments are equal. If, at the same value of torque, and at the same value of the reactive torque, the value of the external torque changes in the direction of increase or decrease, then the device will provide a continuous variability in transmission ratios from the drive shaft 2 to the driven shaft 3, which will begin to rotate, respectively, either with deceleration or acceleration to aligning with the reactive moment.

Thus, the transmission ratios of the claimed device will always correspond to the external torque. In this way, the transmission ratios will continuously vary from the drive shaft 2 to the driven shaft 3 due to normal forces with constant engagement of all toothed wheels of the device.

The proposed mechanical engagement transmission with variable transmission ratios makes it possible to continuously vary the transmission ratios when transferring torque by engagement from one shaft to another, which achieves the result. The embodiment of the proposed technical decision makes it possible to create machines and mechanisms with higher technical characteristics.

1. A device for continuously variable torque transmission comprising a housing, a drive shaft, a driven shaft, and at least first and second auxiliary shafts, wherein a gear is rigidly fixed on the drive shaft, the gear being engaged with a first cylindrical toothed wheel, the first cylindrical toothed wheel being rigidly fixed on a first auxiliary shaft, the gear being engaged with a second cylindrical toothed wheel rigidly fixed on the second auxiliary shaft, wherein axes of differential pinions are rigidly fixed on the first and second auxiliary shafts and are oriented perpendicularly to the first and second auxiliary shafts, wherein ends of the first and second auxiliary shafts include two cone-shaped toothed wheels freely mounted thereto, the two cone-shaped toothed wheels being in contact with cone-shaped toothed wheels of differentials freely mounted on the first and second auxiliary shafts, wherein a first cone-shaped toothed wheel of a first differential on the first auxiliary shaft is rigidly connected to the first cylindrical toothed wheel, the first cylindrical toothed wheel being freely mounted on the first auxiliary shaft and being in contact with another cylindrical toothed wheel rigidly fixed on a first flanged bush freely mounted on the drive shaft, wherein a second cone-shaped toothed wheel of the first differential is rigidly connected to the first cylindrical toothed wheel freely mounted on the drive shaft and in contact with another cylindrical toothed wheel rigidly mounted on the driven shaft, wherein on the second auxiliary shaft, the second cone-shaped toothed wheel of a second differential is rigidly connected to a cylindrical toothed wheel freely mounted on the drive shaft and engaged with another cylindrical toothed wheel freely fixed on a second flanged bush, wherein another cone-shaped toothed wheel of the second differential is rigidly connected to the second cylindrical toothed wheel freely mounted on the drive shaft and which is in contact with the second cylindrical toothed wheel rigidly mounted on the driven shaft, on the second flanged bush, wherein between the second cylindrical toothed wheel rigidly mounted on the second flanged bush, and the flange of the second flanged bush, a sliding bush with a disc is disposed, wherein a fork lever enters into the sliding bush with a disc, wherein a support bearing is mounted on an axis in the housing between the fork lever and the disk of the bush with a disk, levers are installed diametrically on opposite sides of axes of the flange of the flanged bush, wherein the levers contact the disk of the bush with a disk with one end, and enter holes of the second cylindrical toothed wheel with another end, the second cylindrical toothed wheel being freely fixed on the second flanged bush, and wherein springs are installed between the ends of the levers that contact the disk of the bush with a disk and the flange of the second flanged bush.
